(19) United States
(12) Patent Application Publication
(10) Pub. No.: US 2025/0039003 A1
(43) Pub. Date: Jan. 30, 2025

(54) REDACTING CONTENT FROM BLOCKCHAIN TRANSACTIONS

(71) Applicant: nChain Licensing AG, Zug (CH)

(72) Inventors: Mehmet Sabir KIRAZ, Leicester (GB); Jack DAVIES, London (GB); Wai LIU, San Francisco, CA (US)

(21) Appl. No.: 18/696,879

(22) PCT Filed: Sep. 6, 2022
(86) PCT No.: PCT/EP2022/074687

§ 371 Date: Mar. 28, 2024

(30) Foreign Application Priority Data
Oct. 6, 2021 (GB) 2114286.4

(51) Int. Cl. H04L 9/00

(52) U.S. Cl. CPC H04L 9/50

(57) ABSTRACT

A computer-implemented method of redacting data of a blockchain transaction, wherein the method comprises: obtaining a first blockchain transaction, the first blockchain transaction comprising one or more respective scripts comprising respective target data to be redacted; for at least one of the one or more respective scripts, constructing a respective Merkle tree based on the respective script, wherein the respective target data is divided across one or more of the respective leaves of the respective Merkle tree, and generating a redacted version of the first blockchain transaction by replacing the at least one respective script with a respective Merkle root of the respective Merkle tree.

### CROSS REFERENCE TO RELATED APPLICATIONS

This application is the U.S. National Stage of International Application No. PCT/EP2022/074687 filed on Sep. 6, 2022, which claims the benefit of United Kingdom Patent Application No. 2114286.4, filed on Oct. 6, 2021, the contents of which are incorporated herein by reference in their entireties.

### TECHNICAL FIELD

The present disclosure relates to a method of redacting content stored in a blockchain transaction. For example, the method may be used to hide sensitive, private, or illegal data.

### BACKGROUND

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

Nodes of the blockchain network (which are often referred to as “miners”) perform a distributed transaction registration and verification process, which will be described in more detail later. In summary, during this process a node validates transactions and inserts them into a block template for which they attempt to identify a valid proof-of-work solution. Once a valid solution is found, a new block is propagated to other nodes of the network, thus enabling each node to record the new block on the blockchain. In order to have a transaction recorded in the blockchain, a user (e.g. a blockchain client application) sends the transaction to one of the nodes of the network to be propagated. Nodes which receive the transaction may race to find a proof-of-work solution incorporating the validated transaction into a new block. Each node is configured to enforce the same node protocol, which will include one or more conditions for a transaction to be valid. Invalid transactions will not be propagated nor incorporated into blocks. Assuming the transaction is validated and thereby accepted onto the blockchain, then the transaction (including any user data) will thus remain registered and indexed at each of the nodes in the blockchain network as an immutable public record.

The node who successfully solved the proof-of-work puzzle to create the latest block is typically rewarded with a new transaction called the “coinbase transaction” which distributes an amount of the digital asset, i.e. a number of tokens. The detection and rejection of invalid transactions is enforced by the actions of competing nodes who act as agents of the network and are incentivised to report and block malfeasance. The widespread publication of information allows users to continuously audit the performance of nodes. The publication of the mere block headers allows participants to ensure the ongoing integrity of the blockchain.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

### SUMMARY

Blockchains are designed to be immutable, meaning that once a transaction is written to the blockchain, it is considered impossible to alter. However, transaction data may contain private or sensitive information which may need to be protected from unauthorized access. As another example, transaction data may contain content that is illegal in at least some jurisdictions. Data that may be considered private, sensitive, or illegal is termed “secret data” herein and which we term ‘secret’ data due to the need to avoid distributing or granting access to such data. Therefore, the problem arises of how to deal with secret data if it has already been written to the blockchain. It is also important to prevent sharing of secret data on the blockchain, e.g. to properly protect private data and comply with data protection laws. The problem may also be phrased as how to remove or restrict access to the secret data stored in a blockchain transaction, while ensuring that it is possible to prove that any remaining (i.e. non-secret) data belongs to the transaction, and that the transaction can be validated and used in future transactions.

According to one aspect disclosed herein, there is provided a computer-implemented method of redacting data of a blockchain transaction, wherein the method comprises: obtaining a first blockchain transaction, the first blockchain transaction comprising one or more respective scripts comprising respective target data to be redacted; for at least one of the one or more respective scripts, constructing a respective Merkle tree based on the respective script, wherein the respective target data is divided across one or more of the respective leaves of the respective Merkle tree, and generating a redacted version of the first blockchain transaction by replacing the at least one respective script with a respective Merkle root of the respective Merkle tree.

The method enables target data (e.g. secret data) to be redacted (or removed, or concealed) from a blockchain transaction using a Merkle tree. The transaction contains at least one script. The script may be in an input (unlocking script) or output (locking script) of a transaction. The script contains target data-data to be redacted. The target data may be secret data which, as mentioned above, is private, sensitive, or illegal. In general the target data may be any data that is to be removed from a transaction, and does not necessarily have to be private, sensitive, or illegal. For example, the target data may need to be removed from the transaction because of its size, e.g. it may contain a large image or audio file. As another example, the target data may need to be removed from the transaction because it contains a bug or other harmful data (harmful in the sense that it may cause damage to a computer that stores or processes the data).

A Merkle tree is constructed based on the script, i.e. using the script. Different parts of the script are used as different leaves of the Merkle tree. At least one leaf of the Merkle tree includes part of the target data. In some examples, a single leaf node includes the entire target data. In other examples, the target data is divided across multiple leaves. As is known in the art, leaves of the Merkle tree are hashed to form leaf hashes, pairs of leaf hashes are concatenated and hashed to form respective inner hashes. The process of concatenating and hashing pairs of inner hashes is repeated until a single hash remains—the Merkle root. The script is replaced with the Merkle root to form a redacted version of the transaction—a “redacted transaction”. The target data is therefore redacted, or removed, from the transaction by replacing the script that contains the target data with the Merkle root.

The redacted transaction may be stored and/or shared instead of the original version of the transaction, thus preventing the storage and/or distribution of the target (e.g. secret) data.

The method may be performed by a transaction generator, e.g. a user. For example, the method may be performed so as to generate a signature based on the redacted transaction. The method may also be performed by a transaction validator, e.g. a blockchain node. For example, the method may be performed so as to verify a signature based on the redacted transaction, generate a transaction identifier for the redacted transaction, and/or validate the redacted transaction.

In some embodiments, the method may be used to implement a selective disclosure mechanism, allowing a prover to select a subset of transaction content to be disclosed to a verifier while some content remains hidden. The mechanism is script-agnostic and facilitates selective disclosure of content embedded by any script mechanism.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain;

FIG. 2 schematically illustrates some examples of transactions which may be recorded in a blockchain;

FIG. 3 schematically illustrates the structure of an example blockchain transaction containing data embedded in an unspendable output;

FIG. 4 schematically illustrates an example of Merklizing a pay-to-public-key hash (P2PKH) script;

FIG. 5 schematically illustrates an example of Merklizing an unspendable output script;

FIG. 6 is a schematic block diagram of an example high-level architecture for spending Merklized Transactions, where a transaction is created that spends a previous Merklized script, the transaction is broadcast, and a node validates the transaction against the previous Merklized script using the redacted previous transaction;

FIG. 7 schematically illustrates an example redacted transaction, where the redacted fields are indicated by dashed solid line boxes; and.

FIG. 8 schematically illustrates an example of generating a secondary identifier for the redacted transaction.

### DETAILED DESCRIPTION OF EMBODIMENTS

### 1. Example System Overview

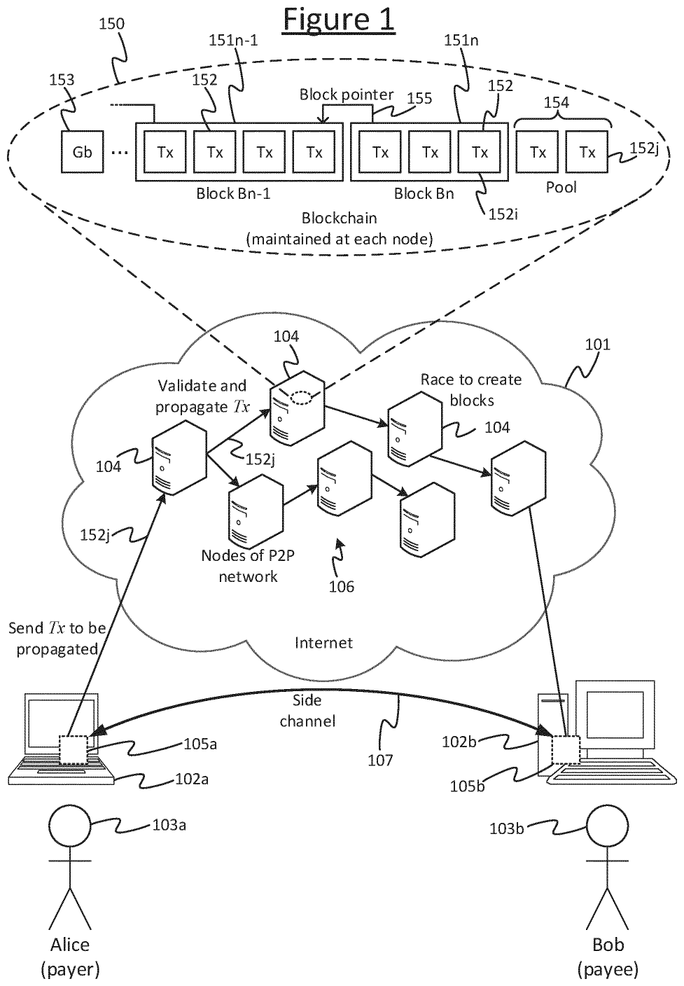

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. Spending or redeeming does not necessarily imply transfer of a financial asset, though that is certainly one common application. More generally spending could be described as consuming the output, or assigning it to one or more outputs in another, onward transaction. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when a party 103, such as an individual user or an organization, wishes to enact a new transaction 152j (either manually or by an automated process employed by the party), then the enacting party sends the new transaction from its computer terminal 102 to a recipient. The enacting party or the recipient will eventually send this transaction to one or more of the blockchain nodes 104 of the network 106 (which nowadays are typically servers or data centres, but could in principle be other user terminals). It is also not excluded that the party 103 enacting the new transaction 152j could send the transaction directly to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the party 103 included in the input of the new transaction 152j matches a condition defined in the output of the preceding transaction 152i which the new transaction spends (or “assigns”), wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned (or “spent”) is whether it has yet been validly redeemed by the input of another, onward transaction 152j according to the blockchain node protocol. Another condition for a transaction to be valid is that the output of the preceding transaction 152i which it attempts to redeem has not already been redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered pool 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this comprises searching for a “nonce” value such that when the nonce is concatenated with a representation of the ordered pool of pending transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n−1 in the chain. The significant amount of effort, for example in the form of hash, required to create a proof-of-work solution signals the intent of the first node 104 to follow the rules of the blockchain protocol. Such rules include not accepting a transaction as valid if it spends or assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the pool of yet-to-be published transactions 154 at any given time, depending on when they started searching for a solution or the order in which the transactions were received. Whoever solves their respective puzzle first defines which transactions 152 are included in the next new block 151n and in which order, and the current pool 154 of unpublished transactions is updated. The blockchain nodes 104 then continue to race to create a block from the newly-defined ordered pool of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to newly assign an additional, accepted amount of the digital asset in a new special kind of transaction which distributes an additional defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction” or “generation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered pool of pending transactions 154 maintained at a given blockchain node 104, that blockchain node 104 will start competing to solve the proof-of-work puzzle on the latest version of their respective pool of 154 including the new transaction 152 (recall that other blockchain nodes 104 may be trying to solve the puzzle based on a different pool of transactions 154, but whoever gets there first will define the set of transactions that are included in the latest block 151. Eventually a blockchain node 104 will solve the puzzle for a part of the ordered pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

### 2. UTXO-Based Model

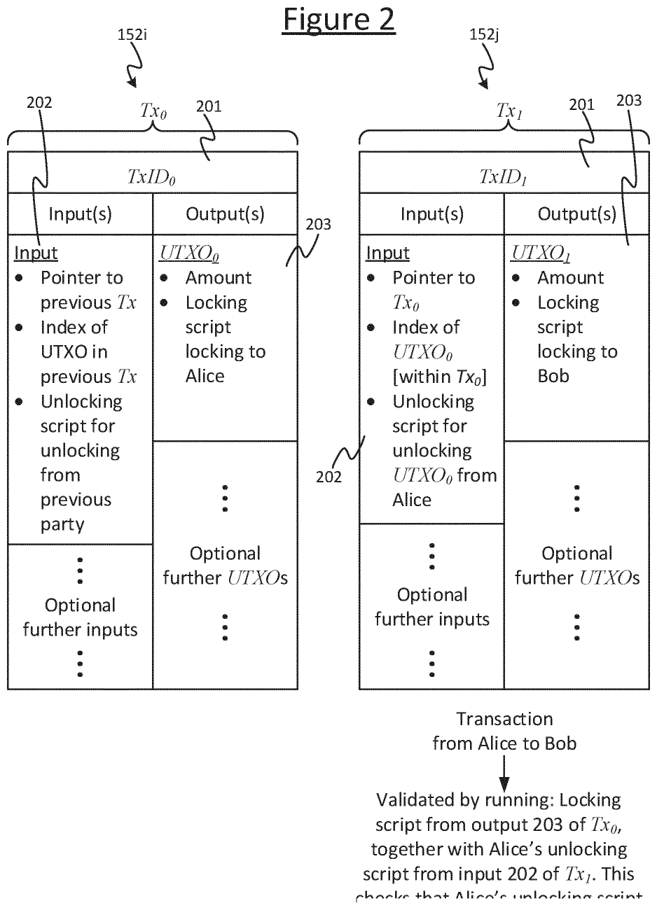

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ could be created and sent to the network 106 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:

$$< Sig {P}_{A} > < {P}_{A} > ‖ [ Checksig {P}_{A} ]$$

where “∥” represents a concatenation and “< . . . >” means place the data on the stack, and “[ . . . ]” is a function comprised by the locking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx₁ contains the signature of Alice signing the expected portion of data. The expected portion of data itself (the “message”) also needs to be included in order to perform this authentication. In embodiments the signed data comprises the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the blockchain node 104 deems Tx₁ valid. This means that the blockchain node 104 will add Tx₁ to the ordered pool of pending transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node 104 that successfully includes her transaction 104 in a block 151. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to Tx₁, and Tx₁ has only one output UTXO₁. If the amount of the digital asset specified in UTXO₀ is greater than the amount specified in UTXO₁, then the difference may be assigned (or spent) by the node 104 that wins the proof-of-work race to create the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_. . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### 3. Side Channel

As shown in FIG. 1, the client application on each of Alice and Bob's computer equipment 102a, 120b, respectively, may comprise additional communication functionality. This additional functionality enables Alice 103a to establish a separate side channel 107 with Bob 103b (at the instigation of either party or a third party). The side channel 107 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 107 may be used to exchange any other transaction related data, such as keys, negotiated amounts or terms, data content, etc.

The side channel 107 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 107 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 107. Note therefore that if it is said that Alice and Bob exchange certain pieces of information or data, or such like, over the side channel 107, then this does not necessarily imply all these pieces of data have to be send over exactly the same link or even the same type of network.

### 4. Redacting Transaction Content

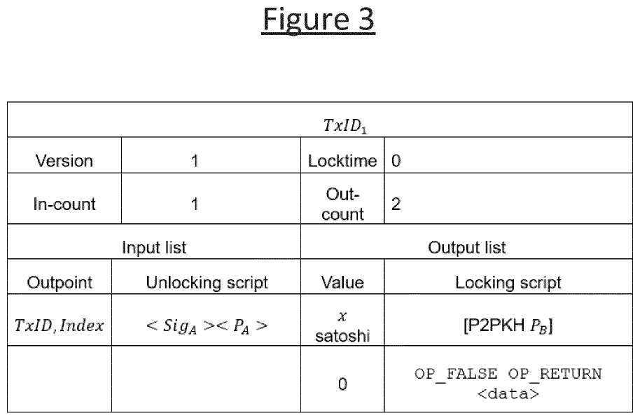

Blockchain transactions include inputs and outputs, each of which include a script. Blockchain scripts (such as Pay-to-Public-Key (P2PK), Pay-to-Public-Key-Hash (P2PKH), Multi-Signature, OP_RETURN) can be used to store arbitrary data in a transaction. Outputs contain scripts that can encode complex locking conditions, as well as storing additional data items that may or may not be part of the locking conditions. For a particular example, arbitrary data may be added to a transaction using an unspendable script pattern known as an OP_FALSE OP_RETURN output. The combination of script opcodes OP_FALSE OP_RETURN that is used to store arbitrary data on the ledger leads to an increase in the size of the blockchain and consumes the disk space of blockchain nodes 104 that wish to store the full data of the blockchain. Some data that is stored on the blockchain may be illicit, illegal, sensitive, or private, etc. Some data may fall into one of those categories at the time of being recorded onto the blockchain, or at a later date. Some data may fall into one of those categories in some jurisdictions, but not others. There is therefore a need to be able to redact data from a transaction so as to decrease the size of the transaction and/or comply with (jurisdiction-dependent) rules and regulations, amongst other reasons. FIG. 3 shows the structure of an example blockchain transaction with an OP_FALSE OP_RETURN payload.

Embodiments of the present disclosure enable the redaction of data that is stored in a blockchain transaction, i.e. data that is included as part of a script in an input or output of a transaction. The data to be redacted is referred to herein as “target data”. The target data may be included as part of an input (unlocking) script. For example, the transaction shown in FIG. 3 includes an unlocking script that comprises the data <Sig_{A}><P_{A}>—a signature and a public key. The target data may be included as part of an output (locking) script. For example, the same transaction includes two locking scripts, both of which contain data. The first locking script includes the data P_{B}—a public key. The second locking script includes the data <data>—any arbitrary data, such as media content, personal details (e.g. name and address), invoice information, etc. The target data may be included as part of a spendable (i.e. transferrable and assignable) output or an unspendable (i.e. non-transferrable and non-assignable) output.

The redaction of the target data may be performed by any entity with access to the original blockchain transaction, which may be any transaction containing data. For brevity, the entity performing the redaction process will be referred to as a “redactor”. In some embodiments, the redactor may be a party such as a user, e.g. Alice 103a or Bob 103b, or rather their respective computer equipment 102a, 102b. In other embodiments, the redactor comprises a blockchain node 104. These embodiments are discussed below.

The redactor obtains a target transaction, i.e. a transaction containing target data to be redacted as part of a script. The redactor may generate the target transaction. For example, the redactor may be a user (e.g. Alice 103a) that generates the transaction. In this case, the redactor may also generate the target data, or the target data may be obtained (e.g. received) from elsewhere. In other examples, the redactor may not be the entity that generated the target transaction. For example, the target transaction may be obtained from the blockchain, or received from a blockchain node 104, or from the transaction generator. For instance, the redactor may be a blockchain node 104 that receives the target transaction from Alice 103a, who generated the target transaction.

Having obtained the target transaction, the redactor generates a Merkle tree using the script (e.g. unlocking or locking script) that includes the target data. The entire script is used to generate the Merkle tree. The target data forms, in its raw form, one or more leaves of the Merkle tree. That is, one or more leaves of the Merkle tree comprise (or consist of) at least part of the target data. In some examples, a single leaf may comprise (or consist of) the target data, meaning the entire target data is included as part of that leaf. Alternatively, the target data may be split across multiple leaves of the Merkle tree, meaning different leaves include a different part of the target data. For example, the target data may be split into equal size chunks, or the target data may be split into a predetermined number of chunks. The target data may instead be divided arbitrarily.

Note that the term “Merkle tree” generally refers to a binary hash tree. However in general, embodiments of the present disclosure may utilise any type of hash tree, e.g. a tertiary hash tree. Therefore any reference to “Merkle tree” may instead by replaced by the more general “hash tree”.

In some examples, the script may include only the target data. For example, an unlocking script may include only target data which was used to unlock an unlocking script of a previous locking script. In that case, the Merkle tree may be based entirely on the target data. However, in practice the script is more likely to contain other components and not just the target data. For instance, the script may include one or more functions that are configured to perform respective operations. On the Bitcoin blockchain these functions are known as opcodes. Additionally or alternatively, the script may include data which is not to be redacted. For example, a script may include a public key hash which may not need to be redacted, and an image file which does need to be redacted. In these examples, the target data only forms part of the Merkle tree, i.e. one or more leaves of the Merkle tree. The function(s) and/or other data also form part of the Merkle tree. That is, one or more leaves of the Merkle tree may comprise (e.g. consist of) one or more functions, and one or more leaves of the Merkle tree may comprise (e.g. consist of) non-target data.

The different components (e.g. functions, target data, other data, etc.) of the script have an order, e.g. from left to right, and that order is respected when constructing the Merkle tree. The leaves of the Merkle tree are formed using the components of the script, in the order in which they appear. For example, the script may include a first set of one or more functions, followed by the target data, followed by a second set of one or more functions. A first set of leaves of the Merkle tree are formed from the first set of functions, a second set of leaves of the Merkle tree are formed from the target data, and a third set of leaves of the Merkle tree are formed from the second set of functions.

In some examples, one or more consecutive functions may be grouped together to form a single leaf of the Merkle tree. In other examples, each function may form a single leaf of the Merkle tree.

In some examples, the script may include a data function (e.g. OP_PUSHDATA, OP_RETURN, etc.) that is configured to indicate the target data when executed. Indicating the target data may comprise outputting the target data to memory (e.g. a stack-based memory) when executed. In these examples, the data function may be separated from the other functions such that it is the only function included in a respective leaf of the Merkle tree. The leaf containing the data function may include other data, such as a length of the target data, e.g. in bytes. Alternatively, the length of the target data may be included as a different leaf of the Merkle tree. The length of the data may be used to determine the number of leaves of the Merkle tree.

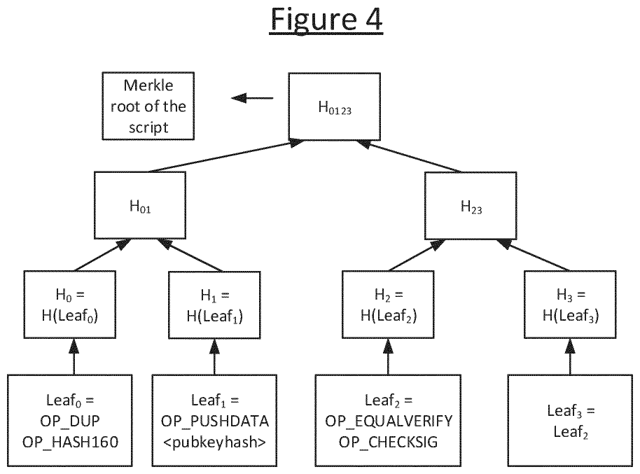

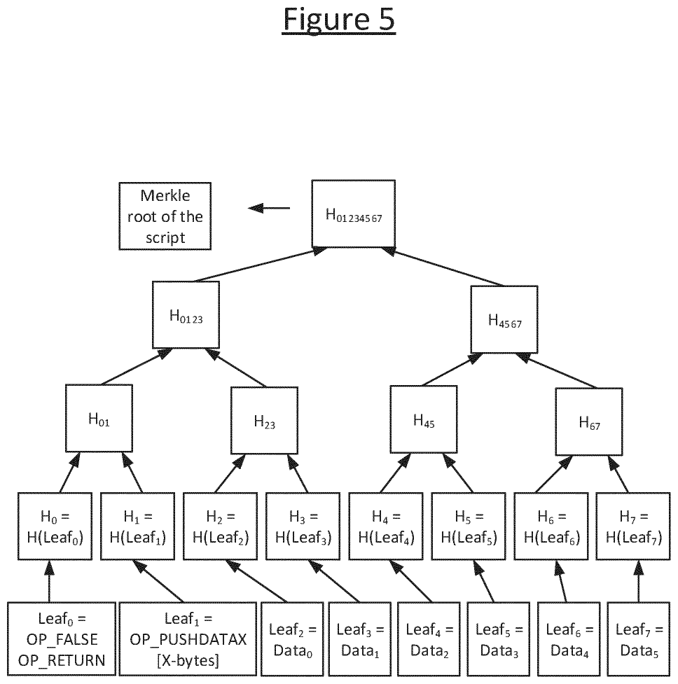

FIGS. 4 and 5, which are discussed in more detail below, illustrate the process of generating a Merkle tree based on scripts containing target data to be redacted. As shown in FIG. 4, from left to right, a first group of functions (opcodes) including form a first leaf, a data function and the target data (<pubkeyhash>) form a second leaf, a second group of functions form a third leaf, and the fourth leaf is formed by duplicating the third leaf. In FIG. 5, a first data function (OP_RETURN) forms part of a first leaf, a second data function (OP_PUSHDATAX) forms part of a second leaf along with the data length ({X-bytes]), and the target data is split over six leaf nodes.

Having generated the Merkle tree based on the script, a redacted version of the target transaction is generated by replacing the script with the Merkle root of the Merkle tree. The target data is thus encoded (and hidden) using the Merkle root.

The target transaction may include multiple respective scripts that comprise respective target data. The process described above of generating a Merkle tree based on a script may be performed for one, some or all of the respective scripts. The respective scripts may then be replaced by the respective Merkle root of the respective Merkle tree.

The redactor may send the redacted transaction to one or more entities, e.g. users 103 or blockchain nodes 104. For instance, the redactor may be a blockchain node 104 who receives a request from a user (e.g. Bob 103b) for the target transaction (not necessarily the redacted version thereof).

The redactor may generate a primary transaction identifier of the redacted transaction. On some blockchains, the primary transaction identifiers (TxID) is generated as the double SHA256 hash (or SHA256d=SHA256 (SHA256(·))) of the serialized transaction (e.g., a 32 bit Version, a 32 bit LockTime, a list of transaction inputs, a list of transaction outputs, etc). The primary transaction identifier TxID′ of the redacted transaction may be generated in a similar way, by hashing the redacted transaction. The hash function used to generate the primary transaction identifier TxID′ may be the SHA256 or double SHA256 hash function. Other hash functions may be used instead, e.g. SHA512.

In the case where the redactor is the transaction generator (e.g. a user, wallet application, etc.), the redactor may generate a signature based on the redacted transaction. Specifically, the signature is based on (i.e. a function of) a message, where the message is based on the redacted transaction. For example, the message may be a serialised version of the transaction. Normally, a signature is based on the scripts of the transaction (whether those scripts be in their raw form or hashed). Now, the signature is based on the Merkle root(s) which replace the script or scripts. The signature signs one or more inputs and/or outputs of the redacted transaction, and is included in an input of the redacted transaction. The signature may be a function of one or more additional items, e.g. a private key. For example, the signature may be an ECDSA signature. Alternative signature schemes may be used. The redacted transaction, signature is included in the target transaction (i.e. the original, non-redacted version of the transaction) and submitted to the blockchain network 106 for validation. That is, the redacted transaction is generated by replacing one or more scripts with respective Merkle roots, the signature is generated based on the redacted transaction and included in the original version of the transaction, and then the signed, original transaction is sent to the blockchain network 106.

As mentioned above, the signature is included in an input of the target transaction. The input references an output of a previous transaction (a “previous output”). The output may include a script that includes target data. Normally, a part of the message to be signed is based on the previous output. Now, when constructing the message, the redactor constructs a Merkle tree based on the script of the previous output (using the method described above) and replaces the script with the Merkle root. The message to be signed is then based on the Merkle root, instead of the script of the previous output.

In the case where the redactor is a transaction validator (e.g. a blockchain node 104), the transaction validator may obtain the target transaction, which includes the signature, and verify that the signature is valid for a message based on the redacted transaction. The message is generated in the same way as described above.

At least one of the scripts of the target transaction may be a locking script-a first locking script. Here, “first” is used as a label and does not necessarily mean the first locking script in a list of locking scripts. The redactor, in the case of the redactor being a transaction validator, may store the Merkle root generated based on the first locking script in a database mapped the modified primary transaction identifier of the target transaction. For example, the modified primary transaction identifier may be a key of a key-value pair, with the Merkle root of the first locking script being the value. If the target transaction has multiple outputs, the index of the output to which the first locking script belongs may form part of the key. The redactor may store a plurality of key-value pairs, where each key relates to a respective output of a respective transaction. The database may be used to validate transactions, as discussed below.

The transaction validator may obtain a second blockchain transaction that comprises an input—a first input—that references an output of the target transaction, e.g. the first output comprising the first locking script. Again, “first” is used here merely as a label for the input that references the output of the target transaction. The first input of the second transaction comprises a first unlocking script. The first output of the target transaction is referenced using the modified primary transaction identifier of the target transaction and the index of the first output. The transaction validator may validate the second transaction in one of several ways.

As a first option, the transaction validator obtains the Merkle root mapped to the referenced output from the database, and determines a partial locking script of the first locking script based on the first unlocking script. A partial locking script comprises part of, but not all of, a locking script, e.g. all of the locking script up until the target data. The partial locking script also comprises one or more hashes of the Merkle tree corresponding to the Merkle root. The hashes may be leaf hashes and/or inner hashes. Each hash is either directly (in the case of a leaf hash) or indirectly (in the case of an inner hash) based on the target data. For example, referring to FIG. 3, a partial locking script may take the following form: OP_DUP OP_HASH160 H₁ H₂₃. The transaction validator may generate the partial locking script or obtain it from elsewhere, e.g. the entity that submitted the second transaction to the blockchain, or a blockchain node 104.

The transaction validator uses the information (e.g. the data and/or functions) contained in the first unlocking script to determine the form of the partial locking script, e.g. the functions that must be (or are at least likely to be) present in the partial locking script. The partial locking script may be determined based on syntactic analysis of the first unlocking script. As an example, if the first unlocking script comprises a signature followed by a public key, the transaction validator may assume that the first locking script comprises a pay-to-public-key-hash script. The partial locking script may be set as the pay-to-public-key-hash script. As another example, the first unlocking script may contain an indication of the form of the partial locking script. The transaction validator may perform a proof of inclusion to confirm that the partial locking script belongs to a Merkle tree corresponding to the Merkle root. Upon confirming that the partial locking script does belong to the Merkle tree and is hence a part of the first locking script, the transaction validator validates the first unlocking script against the partial locking script. The second transaction is rejected if the validation fails.

As a second option, rather than storing the Merkle root of the first output as the value in the key-value pair, the transaction validator may store a partial locking script of the first output as the value in the key-value pair mapped to the modified transaction identifier and the index of the first output. As mentioned above, the partial locking script comprises part of the first locking script in its raw form (not including the target data) and one or more leaf or inner hashes of the Merkle tree generated based on the first locking script. For example, the partial locking script may comprise a set of functions and/or non-target data, and a hash of the target data. Upon obtaining the second blockchain, which references the first output of the target transaction, the transaction validator retrieves the partial locking script from the database and validates the first unlocking script against the partial locking script. In other words, the remaining raw form of the first locking script is executed alongside the first unlocking script. The second transaction is rejected if the validation fails.

As a third option, the first and second options may be combined. That is, the transaction validator may store both the Merkle root and the partial locking script in the database mapped to the modified primary transaction identifier and the index of the first output of the target transaction. In response to receiving the second transaction, the transaction validator may determine the raw part of the partial locking script (e.g. based on analysis of the first unlocking script) and use the partial locking script retrieved from the database to perform a Merkle proof of inclusion to confirm that the raw part is indeed part of the first locking script. The raw part of the partial locking script is then validated against the first unlocking script. The second transaction is rejected if the validation fails.

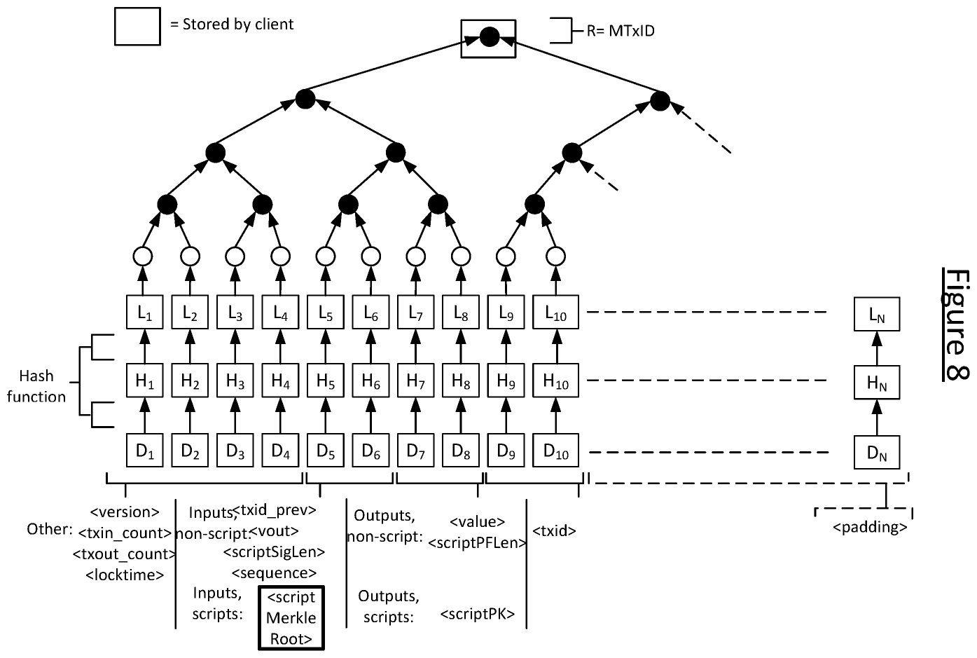

The above description has primarily focused on generating Merkle trees based on individual scripts of the target transaction to generate a redacted transaction. The redactor (whether it be a user 103, blockchain node 104, or other entity) may generate a Merkle tree based on the redacted transaction. That is, a transaction-level Merkle tree is generated, where the leaves of are formed from parts of the redacted transaction. An example is shown in FIG. 8, where at least one of the fields of the redacted transaction comprises a Merkle root, e.g. the Merkle root of FIG. 3 or FIG. 4. The Merkle root of the transaction Merkle tree serves as a second transaction identifier of the redacted transaction. The redacted transaction comprises a plurality of fields, e.g. version number, locktime, one or more inputs, one or more outputs, etc. One or more leaves may comprise some or all of a single respective field. One or more leaves may comprise some or all of multiple respective fields.

The present disclosure thus recognizes a further way in which Merkle trees can be exploited to enable the verification of individual data fields of the redacted transaction. The redacted transaction is split (or parsed) into a set of data fields for generating a Merkle tree, i.e. different parts of the transaction are identified as separate data fields. The Merkle root serves as a novel, secondary identifier of the transaction. A querying user, who may for instance only be operating a lightweight client can perform a proof, using the secondary identifier, to prove the existence of (small) data fields in a transaction, without the need to obtain and hash the full transaction data.

### 5. Selective Disclosure Using Merklized Scripts

This section provides an example of how the embodiments described above can be implemented to redact blockchain content.

In this section, a new mechanism is provided that can be used to selectively disclose transaction data that utilises Merklization of blockchain scripts. At a high level, a Merkle tree is computed for a particular script in a transaction where the script may be an input or an output. The script is parsed from left to right in such a way that each sequence of consecutive opcodes is hashed with a hash function (e.g., SHA256) to create a leaf node. Whenever a <data push> is encountered, the data can be similarly hashed to create a leaf node, or the data can be divided into n chunks where each chunk is hashed to create n leaf nodes. When all the leaf nodes have been created, the Merkle tree root representing the script can be computed.

Due to the features of the Merkle tree, selectively disclosing information can now be achieved very efficiently due to hash computations instead of costly asymmetric operations like signatures, secure multi-party computation, oblivious transfer, and zero knowledge proofs.

### 5.1 Merklized Scripts

In embodiments, all scripts in a transaction are represented in a Merklized form as a “script Merkle tree”. This approach can be summarised by saying that the script Merkle tree is generated from a script by treating each string of consecutive opcodes as a leaf node, each data push as a leaf node, and ordering the leaf nodes of the Merkle tree according to the order they appear in the script. An example algorithm for Merklizing a script scriptMerklize(SCRIPT) is described as follows:
1. Parse the script from left to right:
   a. Each sequence of consecutive opcodes is grouped and the underlying raw representation in bytes are indexed as a leaf.
   b. Each data push of the form <Data>=OP_PUSHDATAX[X bytes] [Data] is treated separately and indexed as a leaf where OP_PUSHDATAX is one of the following opcodes: OP_PUSHDATA1, OP_PUSHDATA2, OP_PUSHDATA4. X is the size of [X bytes].
   c. The leaves are ordered according to their indices, with the left-most leaf corresponding to the left-most part of the script.
2. Hash each leaf to create a leaf node in the Merkle tree. One can alternatively take the double hash (SHA256d=SHA256(SHA256(x)) where x is the pre-message) of each leaf instead.
3. A Merkle tree T is constructed and root R calculated from the leaves, where padding is done in the usual way.
   a. A tree always will have an even number of leaves. If there are an odd number of leaves, one may duplicate the last leaf. For instance, if the last leaf in the tree is the left branch, then that last leaf is duplicated into the right leaf position.

OP_PUSHDATAX and [X bytes] are, respectively, examples of the data function and data length described in section 4. The data length is used to show the length of the redacted data.

In addition to the steps shown above, <Data> elements of a script can be broken down further, in order to allow more granular selective disclosure of different parts of each data push in a particular script. For example, the data contain media content of fixed size frames which can naturally be divided into smaller blocks. In this scenario, we can simply add the following additional to our scriptMerklize( ) algorithm:

Whenever a <data push> is encountered, we can first divide it into n chunks and compute the hash of each chunk to create n leaves. The n value can be fixed, maybe even vary from one script to another. It should also be noted that, in general, each of the chunks do not need to be of equal size.

If we do not divide the data
Leaf=OP_PUSHDATAX[X-Bytes] DATA
then OP_PUSHDATAX[X-bytes] can also be separated from the <Data> as a separate leaf from the n data leaves as follows where one <data push> now becomes n+1 leaves in the tree.
Leaf₀=OP_PUSHDATAX[X-Bytes]
Leaf₁=Data[1]
. . .
Leaf_n=DATA[n]

Remark: There is a trade-off on dividing data into smaller chunks, but at computational cost due to increase in hash function compressions and Merkle tree computation. Let's say the content data is 4480 bits. SHA256 (content data) requires 9 compression functions and we have only 1 leaf. However, if we divide the content data into 448 bits, we have 10 chunks of data, each chunk requires 1 compression function, so total requires 10 compression. The second option also increases the tree depth.

This algorithm produces a Merkle tree from any given script. The root R of this Merkle tree may be used in the updated TxID-generation and SIGHASH algorithms described below. We will now consider applying the above script Merklization algorithm to some example scripts.

### 5.1.1 EXAMPLES

### Example 1: Pay-to-Public-Key-Hash (P2PKH)

Consider a simple ‘Pay-to-Public-Key-Hash’ output, where we can write its script as:

SCRIPT=OP_DUP OP_HASH160 OP_PUSHDATA<pubkeyhash>OP_EQUALVERIFY OP_CHECKSIG
where SCRIPT is chunked into leaves as follows:
Leaf₀=OP_DUP OP_HASH160
Leaf₁=OP_PUSHDATA<pubkeyhash>
Leaf₂=OP_EQUALVERIFY OP_CHECKSIG
Leaf₃=Leaf₂

This example is illustrated in FIG. 4.

Note that the last leaf is duplicated as part of the calculation of the tree. It should also be noted that Merklizing the script does not remove or ‘hide’ the script from the transaction. Instead, when we use the term ‘replace’ what we mean is to use the Merkle root for computations instead of the script itself. We highlight that we need to preserve the ordering of the script and its data elements in the leaves of the Merkle tree because of the onward validation of transactions spending this. Note that ‘onward validation’ here refers to the validation of any future transaction that spends an output of a transaction that has been redacted and had one of its scripts replaced with a Merklization.

The subtlety here is that the validator may need to, in addition to obtaining and executing a non-redacted portion of script, also perform an integrity check (i.e., Merkle proof of inclusion) to prove that the non-redacted script portion was part of the original script before it was partially redacted. An example process for onward transaction validation of this type is detailed below.

As an example of a possible redaction, the P2PKH output in FIG. 4 has been spent (i.e. assigned) in another transaction. Later, this P2PKH output can be redacted (e.g., script for Leaf₁ is redacted). We know that the redacted transaction is valid because we have H(leaf₁) so we can compute the Merkle root of the script and the TxID which matches the transaction already mined. Furthermore, we could even prove that the pubkey in the spending transaction's scriptSig is valid by taking the pubkey and manually recreating leaf₁, OP_PUSHDATA pubkeyhash, and hashing this, to compute a hash value which matches H(leaf 1).

We highlight that this will enable us to validate an onward spend of a redacted transaction efficiently, when compared with alternative more methods of achieving the same effect, which may invoke zero-knowledge-based protocols to prove integrity. The fact that Merkle tree verification tends to be more efficient than performing zero-knowledge proofs means that this method will allow more efficient validation of redacted transactions.

### Example 2: OP_FALSE OP_RETURN

Assume that some data content has been inserted to a transaction with OP_RETURN opcode and it contains some sensitive information (e.g., personal or illegal) and requires a selective disclosure of some parts while hiding others completely. Let
SCRIPT=OP_FALSE OP_RETURN<DATA>
where <DATA>=OP_PUSHDATAX[X-bytes] [Data] with [X-bytes] being the length of [DATA] in bytes.

Next, we construct the leaves of the tree, where each leaf (left to right) is either a set of opcodes or a data push. This means that every data push in the script is a leaf, and each cluster of opcodes is also a push. For example, SCRIPT is chunked into leaves as follows, with the data push divided into granular chunks as described above:

$${Leaf}_{0} = OP\_FALSE OP\_RETURN$$

$${Leaf}_{1} = OP\_PUSHDATAX [ X - bytes ]$$

$${Leaf}_{2} = {Data}_{0}$$

$$...$$

$${Leaf}_{n + 1} = {Data}_{n - 1}$$

$$where [ DATA ] = [ {Data}_{0} ‖ {Data}_{1} ‖ ... {Data}_{n - 1} ] .$$

The data can be in different sizes. A system using this technique can configure n based on different criteria. Let's assume the data has size of 4000 bits. Then, the data can be divided using either of the following rules:
The system fixes and predefines n: Let's assume that the system uses n=6. Each data leaf would then be [4000/6]=666 bits (rounding remainder added to the last chunk). In order to hash this with SHA256, each data leaf input will be padded to 1024 bits (to fill 2 blocks of 512 bits).
The system limits the amount of data associated with a leaf: If the system were to use SHA256 as the hash function, then data can be padded with zero bits to be composed of k blocks of size 512 bits [3]. In the case that the data is 4000 bits, since each chunk is 512 bits, we need to pad the data and we have n=[4000/512]=8 leaf nodes to compress.

FIG. 5 shows an example of a Merklized script with 8 leaves, where the first leaf is the sequence of opcodes ‘OP_FALSE OP_RETURN’ and the remaining leaves are the data divided into 6 chunks.

### 5.2 Security Analysis

Hash functions are subject to offline (brute-force) attacks and the usage will depend on whether the preimage has enough entropy. If there is secret data in a transaction, then it may be necessary to ensure that the secret parts have enough entropy so that brute force attacks would not be possible. More concretely, an adversary should not be able to retrieve the secret from an obfuscated (hashed or encrypted) message. Entropy here refers to the randomness collected by a system for use in algorithms that require random data. A lack of good entropy can leave a security system vulnerable and cannot encrypt/obfuscate data securely. As a general rule of thumb, 128-bits may be considered to be sufficient for all but the most sensitive applications.

Below, we classify how our mechanisms may be used by considering each case separately.
If the entropy of the secret data content is larger than 128 bits:
   Check whether individual chunks of this secret content (i.e., leaves of the Merkle tree) have enough entropy as well. Privacy can still be maintained by concatenating with the adjacent data until we have enough entropy and then only disclose Merkle root of those blocks.
      1. For example, if Leaf₂ does not have enough entropy but it has enough entropy when combined with Leaf₁ and Leaf₃ then only disclose H₄₅₆₇ and Leaf₄, . . . , Leafₙ (i.e., Leaf₀, Leaf₁, Leaf₂, and Leaf₃ are not shared).
If the entropy of the secret data content is less than 128 bits but the entropy of the whole data content is larger than 128 bits:
   The blocked (hidden) chunk is subject to offline attacks if we only hide the secret data content.
   Privacy can still be maintained as follows:
      1. Extract those 128 bits (public as well as secret parts) and concatenate them to increase the entropy,
      2. Make this new value secret, and
      3. Leave the rest of the public part public.
If the entropy of the whole script is less than 128 bits:
   It is subject to offline attacks.
   Still, for the sake of completeness,
      do not disclose any parts of the data except the Merkle root of the data as it will be sufficient to validate the transaction.

### 5.3 Layer-1 Applications of Merklized Scripts

We now consider how the concept of Merklized scripts can be applied to the design of Layer-1 blockchain systems, such as Bitcoin Core. The goal of this section is to investigate how script Merklization may be employed at the protocol level of a Bitcoin-like blockchain to allow nodes 104 to redact transaction information from their copy of the blockchain 150 without sacrificing the ability to verify future transactions related to those that have been redacted.

In the previous section, we discussed in a general sense how to generate a Merkle root for a given script. This Merkle root can then be used in place of the script in existing computations that typically involve hashing the script itself such as the SIGHASH algorithm or TxID computation. The layer-1 proposal in this section affects how TxIDs are computed from transaction data, but does not affect what is included in the transaction message itself. As explained in a later section, the construction of a TxID will use the script Merkle root in place of raw opcodes, but the transaction itself will still contain the scripts in full.

Note that the Merklization of the scripts will typically happen after the original transaction has been broadcast at the time when some of the data needs to be redacted.

The method requires the changes to the following aspects of the existing blockchain implementation:
Transaction ID (TxID) construction
SIGHASH algorithm
Transaction validation

These changes allow for transactions to be validated in the absence of the full, original transaction script data. This is useful in cases where some of the transaction data is identified as illicit at some point after the transaction has been included in a block 151, as it allows nodes 104 to validate onward spends of transaction outpoints containing the illegal data (if a redacted script validation fails, e.g. while bootstrapping a node, it may be assumed that the transaction is valid if it is sufficiently ‘deep’ in the blockchain) and it allows end users to perform proof of existence on the remaining non-illegal data in the transaction.

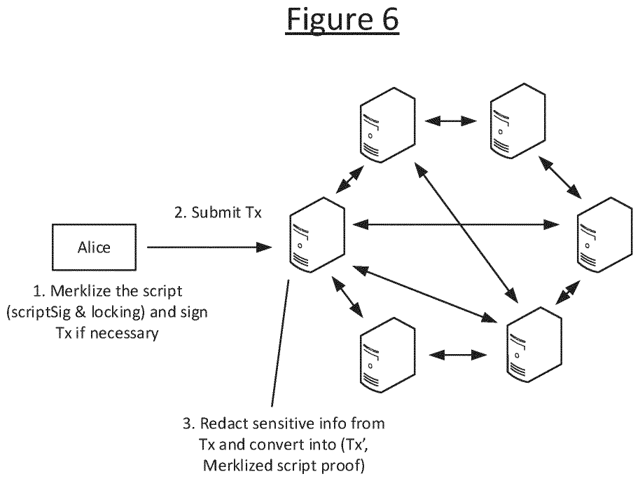

FIG. 6 illustrates an example flow of a transaction. At step 1, the target transaction's scripts are Merklized. The transaction may be signed, e.g. using the modified SIGHASH algorithm described below. At step 2, the original target transaction (which may include the signature generated in step 1) is submitted to the blockchain 150. At step 3, target data is redacted from the transaction by Merklizing the scripts.

### 5.3.1 TxID Construction Protocol is Modified

In the current implementation of Bitcoin, transaction identifiers (TxIDs) are computed as the SHA256d of the raw transaction data Tx, which can be written as:

TxID:=SHA256d(Tx)

However, the computation of the TxID requires the full raw transaction data, which we want to avoid in the case of dealing with illicit or large data that may be undesirable to handle. To accommodate Merklized scripts, the TxID for all transactions may be computed using the new algorithm computeTxID( ) as follows:
1. Obtain the full transaction data of the transaction Tx.
2. Blank out the script data of each script producing a simplified transaction denoted Tx′.
3. In place of each blanked out script, place the Merkle root for that script, as computed previously by the scriptMerklize(SCRIPT) algorithm. The result is Tx″.
4. Compute TxID″=SHA256d (Tx″).

This defines a new (primary) transaction ID, which can be used to uniquely reference transactions without the risk of reconstructing a TxID that depends on redacted script data. Described another way, the transaction has the same TxID even if parts of script are later redacted.

Note that we have chosen to use the SHA256 hash function in this example, meaning that all scripts are replaced by a 32-byte hash digest, irrespective of the size of the script being replaced. If a different hash function is chosen for the script Merklize( ) algorithm, then the length of the replacement digest may differ.

### 5.3.2 SIGHASH Algorithm is Modified

The existing implementation of Bitcoin contains a SIGHASH algorithm, which defines the serialisation of Bitcoin transactions into messages to be signed by ECDSA signatures and used in unlocking scripts. A key feature of the SIGHASH algorithm is that, when generating the serialised message for signing a particular transaction input, it ensures that the message also contains the previous outpoint and previous locking script being consumed in that input. This means that the serialised message to be signed depends explicitly on the previous locking script. Crucially, it is necessary to ensure that this previous locking script was indeed part of the previous transaction, which can be done by verifying the previous locking script was indeed part of the raw transaction Txₚᵣₑᵥ whose double hash produces TxIDₚᵣₑᵥ. The full SIGHASH algorithm, with data types given in brackets, is written as:
1. nVersion in (4-byte little endian)
2. SHA256d of the serialisation of all input outpoints (32-byte hash)
   if ANYONECANPAY flag is set, then this should be a 32-byte zero.
3. SHA256d of the serialisation of nSequence of all inputs (32-byte hash)
   if ANYONECANPAY flag is set, then this should be a 32-byte zero.
4. the outpoint being spent (32-byte for transaction ID+4-byte little endian for index)
5. length in bytes of the subScript (big endian)
6. the subScript (defined below)
7. amount of the output in Satoshis (8-byte little endian)
8. nSequence of this outpoint (4-byte little endian)
9. SHA256d of the serialization of all output amounts and scriptPubKeys. These are taken from the outputs in.
   If SINGLE flag is set and the input index is smaller than the number of outputs, then this should be the double SHA256 of the output with scriptPubKey of the same index as the input.
   If NONE flag is set, then this should be a 32-byte zero.
10. nLocktime of the transaction T (4-byte little endian)
11. sighash type of the signature (4-byte little endian)

Step 6 in the algorithm above is dependent on a subScript, which is generated using the previous locking scripts and prevOuts. The relationship between the previous transaction is as follows:

“A new subScript is created from the previousScriptPubKey. The subScript starts from the most recent OP_CODESEPARATOR (the one just before the OP_CHECKSIG that is [being executed]) to the end of the previousScriptPubKey. If there is no OP_CODESEPARATOR, the previousScriptPubKey becomes the subScript.”

This dependency of the SIGHASH algorithm on the raw previousScriptPubKey presents an issue in cases where the previous locking script being spent may contain data that we wish not to share, such as illegal data. Therefore, if redacted, it can no longer be used and Step 6 fails.

Example of Onward Validation with Redacted Scripts:

We use the term ‘onward validation’ or ‘onward spending’ of a transaction Tx₁ to refer to the validation of any subsequent transaction Tx₂ that spends any output of Tx₁.

For example, let Tx₁ and Tx₂ be transactions already mined in the blockchain:

Tx₁ | Tx₂
OUTPUT | INPUT OUTPUT
LOCKING | UNLOCKING LOCKING
ScriptPubKey --> | scriptSig --> OP_RETURN CONTENT

The following scenarios highlight how the existing SIGHASH algorithm would fail to deal with redacted script data:
Validating Tx₂ where Tx₂ is spending the output of Tx₁ which is later redacted, as SIGHASH involves hashing the redacted outputs scriptPubKey which is now missing data.
Validating Tx₂, where Tx₂ is sending to an output which is later redacted, as SIGHASH involves hashing the OP_RETURN output which is now missing data.

This issue is resolved by replacing the previousScriptPubKey used in the SIGHASH algorithm with the Merkle root for the locking script, which is generated using scriptMerklize(previousScriptPubKey). This means we will be able to run the entire SIGHASH algorithm, and therefore validate signatures, using only the Merkle root of the previous locking script. More generally, all scripts may be replaced with their scriptMerklize( ) root when signing over them. This is a rule that may be implemented in a new version of the SIGHASH algorithm, such that any script signed over by a ECDSA signature is substituted for its Merkle root during the message-construction process.

### 5.3.3 Onward Validation of Transactions

When signing a transaction as described above, the SIGHASH algorithm (depending on the SIGHASH flags) typically involves hashing the output scripts (and other data) into a digest which is then signed. In our new construction, a new serialisation algorithm for the messages is used before signing (e.g., ECDSA). The difference is that the SIGHASH algorithm now uses the Merkle root, rather than the script itself. This enables onward validation of signatures by interested parties, who have only received the redacted transaction over which the signatures may have signed. Note that this modified SIGHASH algorithm will only be invoked in the usual places, i.e. when an OP_CHECKSIG, OP_CHECKSIGVERIFY, OP_CHECKMULTISIG, or and OP_CHECKMULTISIGVERIFY operation is called.

For example, consider the case of a transaction with an output containing OP_FALSE OP_RETURN <data>, where the OP_RETURN data is redacted. In the original Bitcoin transaction, we need the output script of the UTXO to hash over, but with the redacted transaction this data is not available and we cannot reproduce it. Hence, we cannot reproduce the digest which is signed. In our new construction, onward validation is possible if the receiving party who must validate the transaction is provided with the Merkle root of the script, for the purposes of the hashing process for signing. Signatures in the transaction can be verified by performing the same SIGHASH algorithm to generate the digest.

It should be noted that this proposed modification to the SIGHASH algorithm is specifically designed to ensure that the creation and validation of ECDSA signatures is not hampered by the redaction of scripts. Our modification achieves this for all signatures, regardless of whether these signatures attempt to spend redacted outputs.

In the next section, we describe the steps necessary to perform transaction validation in this scenario, such that the redaction of part of one transaction does not prohibit future transactions from spending its outputs.

### 5.3.4 Updated Transaction Validation

In the previous section, we showed how the SIGHASH algorithm can be updated such that it does not depend on the previous locking script of an input in raw form. This allows signatures to be verified without knowing the full previous raw locking scripts. However, when validating a transaction, verifying the ECDSA signature(s) in an unlocking script is only one part of the process. When a spending transaction attempts to spend a locking script that has been partially redacted, it is also necessary to confirm that the part of the previous locking script being satisfied by the spending transaction was in fact part of the original locking script. This can be done by mapping the previous locking script to the previous TxIDₚᵣₑᵥ, which also now encodes the Merklized script.

One way to do this is to map outpoints of the form (TxIDₚᵣₑᵥ, iₚᵣₑᵥ) to locking scripts as (TxIDₚᵣₑᵥ, iₚᵣₑᵥ) [symbol] [Locking script]. We can then use the [Locking script] to retrieve the partial script that is being spent, and use script Merklization to prove that the part being spent was indeed part of the full script, beyond just retrieving it from memory. For example, for a script of the form [Checksig P_{A}]<Data> OP_DROP, we may wish to spend the output without knowing the <Data> component. This means we need to confirm that the [Checksig P_{A}] component was indeed part of the full original locking script, without having access to the <Data> component.

In the existing system, the UTXO database behaves like a key-value store of the form (TxID_{Prev}, iₚᵣₑᵥ): [Locking Script] where the key is an outpoint consisting of an existing transaction identifier TxIDₚᵣₑᵥ and output index iₚᵣₑᵥ, and the value stored against the outpoint is the locking script corresponding to it. When validating a future spend of this output, a high-level description of the process implemented in the node software is as follows:
1. Parse the spending transaction Tx_{current} and obtain the outpoints TxIDₚᵣₑᵥ, iₚᵣₑᵥ referenced by its inputs.
2. For each outpoint j obtained, retrieve the corresponding [Locking script] from the UTXO database.
3. For each input k of Tx_{Current}, validate its [Unlocking script] against the corresponding retrieved [Locking script].
4.

The second step in the above process is where the previous locking script is connected to the referenced outpoint, with the assumption that the UTXO database has been maintained correctly and thus the integrity of the previous locking script is sound.

In the case where a node 104 wishes not to store the entirety of a previous locking script(s), and instead implement the Merklized scripts system we have proposed, then we can alter the above process to ensure the integrity of the partial locking script that is being spent in Tx_{Current}, without needing to know all of its data. A partial locking script may provide some data leaves, and hide others, and possibly only including the hash of the hidden data leaves. For example, if the previous locking script is OP_CHECKSIG OP_FALSE OP_RETURN <data>, instead of storing this full script a node 104 may instead just store OP_CHECKSIG and the corresponding leaf hash for the OP_RETURN data leaves of the Merklized form of this script.

There are broadly three ways in which we can look to alter the UTXO database implementation to this end; by 1) storing the Merklized script root(s), 2) the partial script that is desired, or 3) a combination of the two.

### 5.3.4.1 Merkle Root Storage

In the case where the UTXO database stores script Merkle roots, it will operate like a key-value store of the form (TxIDₚᵣₑᵥ, iₚᵣₑᵥ): [Merkle root], where [Merkle root] is the resultant root R of applying the scriptMerklize( ) algorithm to [Locking script].

The transaction validation process may then be altered in the following way to ensure the integrity of the previous locking script(s) being consumed in Tx_{Current}:
1. Parse the spending transaction Tx_{current} and obtain the outpoints (TxID_{Prev}, iₚᵣₑᵥ) referenced by its inputs.
2. For each outpoint j obtained:
   2.1 Retrieve the corresponding [Merkle root] from the UTXO database.
   2.2 Parse the [Unlocking script] of Tx_{Current} to determine the [Partial Locking Script] being spent by the transaction.
   2.3 Perform a Merkle proof of inclusion to confirm that [Partial Locking Script] is a member of the set under [Merkle Root].
3. For each input k of Tx_{Current}, validate its [Unlocking script] against the corresponding retrieved and integrity-checked [Partial Locking script].

Note that in Step 2.2 we have used syntactic analysis to determine the previous partial unlocking script. However, this could be replaced in implementation in a number of ways, e.g., if the inputs of Tx_{Current} contain an explicit indication of the partial script being satisfied. This partial script could also be delivered as part of the messaging protocol between the transaction submitter and validator.

### 5.3.4.2 Partial Script Storage

In the case where the UTXO database stores partial scripts, it will operate like a key-value store of the form “TxIDₚᵣₑᵥ, Index_{Prev}: [Partial locking script]”, where [Partial locking script] is the portion(s) of the locking script that the Bitcoin node chooses to keep, when other script data is pruned and removed.

The transaction validation process may then be altered in the following way to ensure the integrity of the previous locking script(s) being consumed in Tx_{Current}:
1. Parse the spending transaction Tx current and obtain the outpoints TxIDₚᵣₑᵥ, Index_{Prev} referenced by its inputs.
2. For each outpoint j obtained, retrieve the corresponding [Partial locking script] from the UTXO database.
3. For each input k of Tx_{Current}, validate its [Unlocking script] against the corresponding retrieved [Partial locking script].

This case is identical to the existing implementation, other than the retrieved script is only part of the full previous locking script. Again, we are using the assumption that the integrity of the UTXO database and thus of [Partial locking script] is assured by the node 104 having previously processed the entire history of the blockchain

We note that there could be multiple versions of the previous locking script, blocked in different ways, as nodes who have been asked to block content, may block different data depending on for example jurisdiction, court order, and preference. If the UTXO database stores multiple partial previous locking scripts against the same outpoint, e.g. “TxIDₚᵣₑᵥ, Index_{Prev}: [Partial script 1] [Partial script 2]”, then we may also need to indicate which partial script should be retrieved in order to correspond to the spending unlocking script on Tx_{Current}. For example, assume that a transaction contains medical records with multiple different fields A, B, C. It may be necessary to block field A and C in one jurisdiction (e.g., US), while only A and B in another (e.g., UK). Therefore, a miner servicing both the US and UK would need to have both views of the transaction based on the different blocking criteria.

This is particularly relevant in cases where the previous unlocking script may have multiple different branches that can be satisfied independently. Namely, a transaction with OP_IF branches can be validated with very different unlocking scripts, and perhaps one miner will keep the OP_IF . . . part but another would keep the OP_ELSE . . . part. Each miner can only validate a spend of this script based on one of the two ‘views’ of the Tx, depending on which is blocked. As in the Merkle root storage case, this can be done by supplying an indication of which previous locking script portion is being satisfied by the input of Tx_{Current}.

### 5.3.4.3 Combined Storage

In the final case, a node 104 may wish to implement the UTXO database by storing both script Merkle roots and partial scripts against the outpoints in the UTXO set. This would allow the node to re-generate Merkle proofs required to validate spending transactions on-the-fly, rather than sourcing them from an external source.

The transaction validation process may then be altered in the following way to ensure the integrity of the previous locking script(s) being consumed in Tx_{Current}:
1. Parse the spending transaction Tx current and obtain the outpoints (TxIDₚᵣₑᵥ, iₚᵣₑᵥ) referenced by its inputs.
2. For each outpoint j obtained:
   2.1 Retrieve the corresponding [Merkle root] from the UTXO database.
   2.2 Parse the [Unlocking script] of Tx_{Current} to determine the [Partial Locking Script] being spent by the transaction.
   2.3 Obtain a Merkle proof for the specific [Partial Locking Script] by using the leaves generated by the remaining partial locking scripts.
   2.4 Perform a Merkle proof of inclusion to confirm that [Partial Locking Script] is a member of the set under [Merkle Root].
3. For each input k of Tx_{Current}, validate its [Unlocking script] against the corresponding retrieved and integrity-checked [Partial Locking script].

Note that this updated validation method is identical to the case where the node stored only the script Merkle root, other than the addition of Step 2.3 where the Merkle proof is here generated from the other partial script data stored in the UTXO database.

5.3.5 Blocking Transaction Content with Selective Disclosure of Data Leaves

In this section, we describe the proof of inclusion of sensitive data that is to be blocked where given a Merkle root, the leaves (i.e., public data in plain form), and hash values of leaves (of blocked data), one can easily validate the correctness of the transaction.

In the following, we provide for a particular script (OP_FALSE OP_RETURN) but one can easily generalize to any Bitcoin script. Let
Leaf₀=OP_FALSE OP_RETURN OP_PUSHDATA
Leaf₁=Data₀
Leaf₂=Data₁
. . .
Leafₙ=Dataₙ₋₁

Assume that OP_RETURN data contains secret or illegal content. In such a case, we would share maximum number of data blocks and child hashes in such a way that they do not disclose any information about the secret content while Merkle root could still be computed. For example, assume that the transaction TxID contains

$$Data = {Leaf}_{1} ‖ {Leaf}_{1} ‖ ... ‖ {Leaf}_{n}$$

where Leaf₂ and Leaf₅ contain secret content not to share. In order to prove the existence of the non-secret parts while blocking the private parts, given TxID, if one shares Leaf₁, SHA256 (Leaf₂), Leaf₃, Leaf₄, SHA256 (Leaf₅), Leaf₆, . . . , Leafₙ, then it is still possible to compute the Merkle root of the data and validate the transaction (through TxID) without disclosing the secret content. Note that when Leaf₂ and Leaf₅ are missing, the verifier cannot compute the Merkle root of the OP_RETURN data. Without the Merkle root of the OP_RETURN data, one cannot compute the TxID since our new TxID format needs the Merkle root. However, if we provide H (Leaf₂) and H (Leaf₅) then the verifier can easily compute the Merkle root. Hence, H(leaf₂), H(leaf₅) are parts of the partial locking script required to perform the verification.

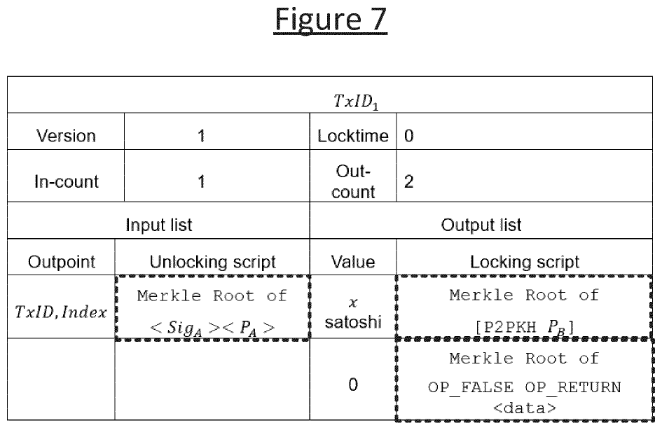

FIG. 7 show an example transaction containing a spendable output and an unspendable output. The example shows how the transaction is viewed both from the perspective of TxID-computation and transaction validation.

### 5.4 Transaction Merkle Tree

As mentioned above, a Merkle tree may be generated using fields of the redacted transaction in order to generate a secondary transaction identifier of the redacted transaction, e.g. for use in determining whether or not that transaction comprises a particular piece of data, referred to as a “candidate data field”. The secondary transaction identifier is so-called since in most blockchain protocols, each transaction is associated with a primary transaction identifier, usually generated by hashing (or double-hashing) the entire transaction.

An example technique comprises splitting a transaction field-wise into a set of data packets (or data fields) that can be used as the leaves of a Merkle tree, with the root of the Merkle tree corresponding to the secondary transaction identifier. Here, splitting is equivalent to identifying data fields of the transaction. In other words, the transaction does not actually have to be “divided”. Instead, different parts of the transaction may be identified (e.g. assigned) as different ones of the set of data fields. The secondary transaction identifier will be unique to a given transaction (e.g. a unique 256-bit numeric representation (a hash value) of the given transaction). This hash value can be used to verify whether any individual field was a valid leaf of the Merkle tree without obtaining the entire set (i.e. the full transaction).

Given a transaction Tx, one way to verify that it has been included in a block of the blockchain is to verify that its corresponding TxID (primary transaction identifier) appears in a block. This check can done by performing a Merkle tree proof (e.g. a Merkle proof) to verify that the transaction corresponding to TxID is part of the transaction set represented by the hash root in the block header. However, this check requires the verifier to first obtain the full transaction message m=Tx and affirm that TxID=H(Tx) does in fact hold for the given Tx and the supposed TxID, where H is a hash function. This may be problematic for some users of the blockchain, in particular, when the user implements a lightweight client and/or the message m is large.

In examples a secondary transaction identifier MTxID may be generated that obeys the following definition: MTxID:=F(Tx, TxID). The algorithm F acts as a one-way function that generates a secondary transaction identifier from two input messages, Tx and TxID. Given the fact that a TxID can be written as a function of a transaction message Tx as TxID:=H²(Tx), this means MTxID can be written as a function of a single message m=Tx in the following way: MTxID:=F(Tx, H²(Tx)):=F(Tx). The algorithm F comprises a Merkle tree generator. The algorithm takes a full transaction as input Tx and returns a hash digest MTxID, which we can use as a secondary identifier for the transaction. The secondary identifier may be a 256-bit hash digest. It should be appreciated that the secondary identifier MTxID does not replace the primary identifier TxID in this scheme. To reinforce this, the design of the algorithm F includes the generation of TxID, e.g. using the typical double-hashing function H²(Tx), which binds the secondary identifier to the primary identifier.

The method for generating a secondary transaction identifier MTxID can be split into three main stages, as summarised below.
Input: Tx
F(Tx):
1) Calculate TxID:=H²(Tx) (note that this is an optional step).
2) Separate Tx into a set [symbol] of N=2^{k} ordered data packets, [symbol] :={D₁, D₂, . . . , D_{N}}.
3) Generate a binary Merkle tree T using the packets of set [symbol] as the leaves and calculate its root R.
Output: MTxID=R

### 5.4.1 Stage 1: Calculation of TxID

The method may comprise generating a primary transaction identifier by hashing the transaction. The first stage is a SHA-256 double-hash calculation, performed on the Tx, which generates the primary transaction identifier TxID. Other hash functions may be used, and in some examples only a single hash calculation is performed. Usually the Tx message itself does not include the TxID explicitly. The subsequent stages of therefore require this explicit pre-calculation of TxID, such that the Merkle tree can be constructed in a way that encodes this primary identifier explicitly.

5.4.2 Stage 2: Separation of Tx into Ordered Data Set D

The transaction data comprising the message Tx is separated into discrete packets that can be used as the leaves of a Merkle tree T. The transaction may be split into its existing fields. Most of these fields contain simple numeric data which will generally be very small in size-typically ranging between 1 and 32 bytes. Therefore most of the transaction is related to the sigScript and scriptPubKey fields, which relate to inputs (unlocking) and outputs (locking) respectively. The fields of a transaction may be distinguished using three categories: input fields, output fields and other fields. In some examples, the transaction is split into these three categories, e.g. one data field comprising all input fields, one data field comprising all output fields, and one data field comprising the other fields. The input and output fields may be separated into non-script and script fields, the non-script field comprising numeric data and the script field comprising script data.

The following table shows ways in which a transaction may be split into a set of data fields.

| | Size | Input, Output | Script or |
|---|---|---|---|
| Field | (Bytes) | or Other? | Non-script? |
| version | 4 | other | |
| txin_count | 1-9 | other | |
| tx_in [ ] | | | |
| txid_prev | 32 | input | non-script |
| vout | 4 | input | non-script |
| scriptSigLen | variable | input | non-script |
| scriptSig | variable | input | script |
| sequence | 4 | input | non-script |
| txout_count | 1-9 | other | |
| txout [ ] | | | |
| value | 8 | output | non-script |
| scriptPubKeyLen | variable | output | non-script |
| scriptPubKey | variable | output | script |
| locktime | 4 | other | |

This table demonstrates that a Tx message can be split into its component fields to form a set of packets [symbol] in several ways.

In some examples, the transaction may be split into at least one data field comprising input data of the transaction (e.g. txid_prev); at least one data field comprising output data of the transaction (e.g. value); and at least one data field comprising non-input and non-output data (i.e. the other data, e.g. version) of the transaction. Each data field may consist of data of only one type, e.g. only input data.

In other examples, the transaction may be split into more data fields. For instance, the set of data fields may comprise: at least one data field comprising script input data of the transaction (e.g. scriptSig); at least one data field comprising non-script input data of the transaction (e.g. vout); at least one data field comprising script output data of the transaction of the transaction (e.g. scriptPubkey); and at least one data field comprising non-script output data of the transaction of the transaction (e.g. scriptPubKeyLen).

Note that according to the present disclosure, each scriptSig and scriptPubKey may be replaced with the corresponding Merkle root of the Merkle tree generated based on the respective script.

The transaction Tx may be split into the following set of ordered data packets:

$${D}_{1} = < version > ,$$

$${D}_{2} = < txin\_count > ,$$

$${D}_{3} = < txout\_count > ,$$

$${D}_{4} = < locktime > ,$$

$${D}_{5} = < txid\_prev > ‖ < vout > ‖ < scriptSigLen > ‖ < sequence > ,$$

$${D}_{6} = Merkle root of < scriptSig > ,$$

$${D}_{7} = < value > ‖ < scriptPubKeyLen > ,$$

$${D}_{8} = Merkle root of < scriptPubKey > .$$

The choice to split the data in this way has several benefits if each packet Dᵢ is a leaf of a binary Merkle tree. First, all non-script inputs are concatenated to form packet D₅ and similarly all non-script outputs are concatenated to form D₇. This means that every input and output of a transaction is split into exactly two parts—the non-script component and the script component (or rather, the Merkle root thereof). This is advantageous as it means every input and output can be paired as sibling leaves. The inputs and outputs may therefore be separated from other fields entirely, and the script and non-script components of each input or output may also be separated.

In addition to these fields, the TxID may also be included as a leaf in the Merkle tree T. Following on from the above example, this means include the data field D₉=<TxID>. In general, there may be many inputs and many outputs in a transaction, each of which may be split into two components by the algorithm F. The total number of data blocks N=|D| in this tree T will therefore be given by the equation

$$N = {\underbrace{4}}_{\begin{matrix}Other \\ fields\end{matrix}} + {\underbrace{( 2 \times {n}_{in} )}}_{input fields} + {\underbrace{( 2 \times {n}_{out} )}}_{output fields} + {\underbrace{1}}_{TxID} ,$$

where nᵢₙ, nₒᵤₜ are the number of transaction inputs and outputs respectively. In some examples, all the other data fields may be concatenated to form a single data field. This reduces the total number of leaves to N=2+2 (nᵢₙ+nₒᵤₜ).

In the case that there is no k∈ [symbol] * such that N=2^{k}, 2^{k}−N>0 data packets of null padding data may be added to ensure there are enough leaves of the Merkle tree. This padding could either be null data or it could be 2^{k}−N copies of the TxID so as to reinforce the link between the primary transaction identifier and the eventual secondary identifier MTxID.

### 5.4.3 Stage 3: Generation of the Merkle Tree T Using D and Calculation of Root R

The method comprises using the set of data fields as leaves of a transaction Merkle tree. The transaction Merkle tree comprises a leaf layer, one or more internal layers and a root layer. The leaf layer comprises a plurality of leaf nodes (also referred to as leaf hashes as each node is a hash digest). Each leaf node is generated by hashing a respective data field of the transaction. At least one of the leaf hashes is based on the primary transaction identifier. In some examples, one or more leaf hashes are generated by hashing the primary transaction identifier. In some examples, one or more fields of the transaction are concatenated with the primary transaction identifier and then hashed to generate respective leaf hashes. Each internal layer comprises a plurality of internal nodes (or internal hashes). Each internal hash in a given internal layer is generated by hashing a concatenation of at least two hashes from a lower layer. E.g. the first or lowermost internal layer (i.e. the internal layer connected directly to the leaf layer) comprises internal nodes generated by hashing a concatenation of at least two leaf hashes. The root layer comprises a Merkle root of the transaction tree, i.e. the secondary transaction identifier. The secondary transaction identifier is generated by hashing a concatenation of the internal hashes of an uppermost internal layer of the one or more internal layers (i.e. the internal layer connected directly to the root layer).

The secondary transaction identifier (the Merkle root of the transaction Merkle tree) may be included in the generation transaction of the block. The block may then be recorded in the blockchain. Alternatively, as described below, a secondary transaction identifier may be included in a transaction that is transmitted to a node via one or more nodes of the network.

The algorithm F takes the ordered set of data packets D and constructs a Merkle tree T by using these packets as the leaves. FIG. 8 shows an example construction of a binary Merkle tree. In this example the first four data fields D₁, . . . , D₄ are the other fields of a transaction, the next 2×(nᵢₙ+nₒᵤₜ) data fields are the input and output fields represented as pairs of script D₅, D₆ and non-script D₇, D₈ field data. The remaining data fields include at least one field D₉, D₁₀ containing TxID and any padding D_{N} required to reach N=2^{k} for some integer k.

### 6. Further Remarks

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

It will be appreciated that the above embodiments have been described by way of example only. More generally there may be provided a method, apparatus or program in accordance with any one or more of the following Statements.
Statement 1. A computer-implemented method of redacting data of a blockchain transaction, wherein the method comprises:
   obtaining a first blockchain transaction, the first blockchain transaction comprising one or more respective scripts comprising respective target data to be redacted;
   for at least one of the one or more respective scripts, constructing a respective Merkle tree based on the respective script, wherein the respective target data is divided across one or more of the respective leaves of the respective Merkle tree, and
   generating a redacted version of the first blockchain transaction by replacing the at least one respective script with a respective Merkle root of the respective Merkle tree.
Statement 2. The method of Statement 1, wherein each respective script comprises one or more functions, and wherein said constructing of the respective Merkle tree comprises grouping one or more respective sequences of consecutive functions as respective leaves of the Merkle tree.
Statement 3. The method of Statement 2, wherein each respective script comprises a respective data function configured to indicate the respective target data when executed, and wherein said constructing of the respective Merkle tree comprises including the respective data function as part of a respective leaf of the respective Merkle tree.
Statement 4. The method of Statement 3, wherein each respective script comprises a respective data length of the respective target data, and wherein said constructing of the respective Merkle tree is based on the respective data length.
Statement 5. The method of Statement 4, wherein said constructing of the respective Merkle tree comprises including the respective data length as part of the same respective leaf of the respective Merkle tree as the respective data function.
Statement 6. The method of any preceding Statement, wherein the respective target data is divided across a plurality of the respective leaves of the respective Merkle tree.
Statement 7. The method of any preceding Statement, wherein the first blockchain transaction comprises a plurality of respective scripts comprising respective target data, and wherein the method comprises:
   for each of the plurality of respective scripts, constructing a respective Merkle tree based on the respective script, wherein the respective target data is divided across one or more of the respective leaves of the respective Merkle tree;
   generating the redacted version of the first blockchain transaction by replacing each respective script with a respective Merkle root of the respective Merkle tree.
Statement 8. The method of any preceding Statement, comprising generating a primary transaction identifier of the redacted version of the first blockchain transaction by hashing the redacted version of the blockchain transaction.
Statement 9. The method of any preceding Statement, comprising transmitting the redacted version of the blockchain transaction to an entity in response to a request for the first blockchain transaction.
Statement 10. The method of any preceding Statement, comprising storing the redacted version of the first blockchain transaction in memory.
Statement 11. The method of any preceding Statement, wherein the method is performed by a transaction generator.
Statement 12. The method of Statement 11, comprising:
   generating a signature for a message, wherein one or more parts of the message are based on the redacted version of the first blockchain transaction;
   including the signature in an input of the first blockchain transaction; and
   submitting the first blockchain transaction to the blockchain network for validation.
Statement 13. The method of Statement 12, wherein the signature is an elliptic curve digital signature algorithm, ECDSA, signature.
Statement 14. The method of Statement 12 or Statement 13, wherein the input references an output of a previous blockchain transaction that comprises a respective script comprising respective target data, wherein part of the message is based on the output of the previous blockchain transaction, and wherein the part of the message that is based on the output of the previous blockchain transaction is based on a Merkle root of a Merkle tree constructed based on the respective script, wherein the respective target data is divided across one or more of the respective leaves of the respective Merkle tree.
Statement 15. The method of any of Statements 1 to 10, wherein the method is performed by a transaction validator.
Statement 16. The method of Statement 15, comprising:
   extracting a signature from an input of the first blockchain transaction; and
   verifying the signature for a message, wherein one or more parts of the message are based on the redacted version of the first blockchain transaction.
Statement 17. The method of Statement 16, wherein the input references an output of a previous blockchain transaction that comprises a respective script comprising respective target data, wherein part of the message is based on the output of the previous blockchain transaction, and wherein the part of the message that is based on the output of the previous blockchain transaction is based on a Merkle root of a Merkle tree constructed based on the respective script, wherein the respective target data is divided across one or more of the respective leaves of the respective Merkle tree.
Statement 18. The method of Statement 15 or any Statement dependent thereon, comprising storing the redacted version of the first blockchain transaction on the blockchain.
Statement 19. The method of Statement 8 and any of Statements 15 to 18, wherein at least one of the respective scripts is a first locking script of a first output of the first blockchain transaction, and wherein the method comprises:
   storing, in a database, the respective Merkle root mapped to the modified primary transaction and a respective index of the first output.
Statement 20. The method of Statement 19, comprising:
   obtaining a second blockchain transaction, wherein the second blockchain transaction comprises a first input that references the modified primary transaction identifier of the first blockchain transaction and the index of the first output, wherein the first input comprises a first unlocking script, and wherein the method comprises validating the second blockchain transaction by:
   retrieving, from the database, the respective Merkle root mapped to the modified primary transaction identifier and the respective index of the first output;
   determining a partial locking script of the first output based on the first unlocking script of the first input;
   performing a Merkle proof of inclusion to confirm that the partial locking script is a respective leaf of the respective Merkle tree corresponding to the respective Merkle root; and
   validating the first unlocking script against the partial locking script.
Statement 21. The method of Statement 8 and any of Statements 15 to 18, wherein at least one of the respective scripts is a first locking script of a first output of the first blockchain transaction, and wherein the method comprises:
   storing, in a database, a partial locking script mapped to the modified primary transaction identifier and a respective index of the first output, wherein the partial locking script comprises at least some of the first locking script but not the target data.
Statement 22. The method of Statement 21, comprising:
   obtaining a second blockchain transaction, wherein the second blockchain transaction comprises a first input that references the modified primary transaction identifier of the first blockchain transaction and the index of the first output, wherein the first input comprises a first unlocking script, and wherein the method comprises validating the second blockchain transaction by:
   retrieving, from the database, the respective partial locking script mapped to the modified primary transaction identifier and the respective index of the first output; and
   validating the first unlocking script against the partial locking script.
Statement 23. The method of Statement 19 and Statement 21, comprising:
   retrieving, from the database, the respective Merkle root and partial locking script mapped to the modified primary transaction identifier and the respective index of the first output;
   determining a partial locking script of the first output based on the first unlocking script of the first input;
   obtaining a Merkle proof for the determined partial locking script using one or more respective leaves generated based on the retrieved partial locking script;
   performing a Merkle proof of inclusion to confirm that the determined partial locking script is a respective leaf of the respective Merkle tree corresponding to the respective Merkle root; and
   validating the first unlocking script against the determined partial locking script.
Statement 24. The method of any preceding Statement, wherein the redacted transaction comprises a plurality of fields, and wherein the method comprises:
   generating a transaction Merkle tree, wherein respective a plurality of respective leaves of the transaction Merkle tree are formed from one or more fields of the redacted transaction; and
   generating a secondary transaction identifier of the redacted transaction, wherein the secondary transaction identifier comprises a Merkle root of the transaction Merkle tree.
Statement 25. The method of Statement 24, wherein one or more leaves of the transaction Merkle tree are formed from multiple fields of the redacted transaction.
Statement 26. The method of Statement 24 or Statement 25, wherein one or more leaves of the transaction Merkle tree are formed from a single field of the redacted transaction.
Statement 27. The method of Statement 24 or any Statement dependent thereon, wherein one or more leaves of the transaction Merkle tree are formed from a respective part of a respective field of the redacted transaction, but not the complete respective field.
Statement 28. Computer equipment comprising:
   memory comprising one or more memory units; and
   processing apparatus comprising one or more processing units, wherein the memory stores code arranged to run on the processing apparatus, the code being configured so as when on the processing apparatus to perform the method of any of Statements 1 to 27.
Statement 29. A computer program embodied on computer-readable storage and configured so as, when run on one or more processors, to perform the method of any of Statements 1 to 27.

1. A computer-implemented method of redacting data of a blockchain transaction, wherein the method comprises:
obtaining a first blockchain transaction, the first blockchain transaction comprising one or more respective scripts comprising respective target data to be redacted;
for at least one of the one or more respective scripts, constructing a respective Merkle tree based on the respective script, wherein the respective target data is divided across one or more of the respective leaves of the respective Merkle tree, and
generating a redacted version of the first blockchain transaction by replacing the at least one respective script with a respective Merkle root of the respective Merkle tree.

2. The method of claim 1, wherein each respective script comprises one or more functions, and wherein said constructing of the respective Merkle tree comprises grouping one or more respective sequences of consecutive functions as respective leaves of the Merkle tree.

3. The method of claim 2, wherein each respective script comprises a respective data function configured to indicate the respective target data when executed, and wherein said constructing of the respective Merkle tree comprises including the respective data function as part of a respective leaf of the respective Merkle tree.

4. The method of claim 3, wherein each respective script comprises a respective data length of the respective target data, and wherein said constructing of the respective Merkle tree is based on the respective data length.

5. The method of claim 4, wherein said constructing of the respective Merkle tree comprises including the respective data length as part of the same respective leaf of the respective Merkle tree as the respective data function.

6. The method of claim 1, wherein the respective target data is divided across a plurality of the respective leaves of the respective Merkle tree.

7. The method of claim 1, wherein the first blockchain transaction comprises a plurality of respective scripts comprising respective target data, and wherein the method comprises:
for each of the plurality of respective scripts, constructing a respective Merkle tree based on the respective script, wherein the respective target data is divided across one or more of the respective leaves of the respective Merkle tree;
generating the redacted version of the first blockchain transaction by replacing each respective script with a respective Merkle root of the respective Merkle tree.

8. The method of claim 1, comprising generating a primary transaction identifier of the redacted version of the first blockchain transaction by hashing the redacted version of the blockchain transaction.

9. The method of claim 1, comprising transmitting the redacted version of the blockchain transaction to an entity in response to a request for the first blockchain transaction.

10. The method of claim 1, comprising storing the redacted version of the first blockchain transaction in memory.

11-14. (canceled)

15. The method of claim 1, wherein the method is performed by a transaction validator.

16. The method of claim 15, comprising:
extracting a signature from an input of the first blockchain transaction; and
verifying the signature for a message, wherein one or more parts of the message are based on the redacted version of the first blockchain transaction.

17. The method of claim 16, wherein the input references an output of a previous blockchain transaction that comprises a respective script comprising respective target data, wherein part of the message is based on the output of the previous blockchain transaction, and wherein the part of the message that is based on the output of the previous blockchain transaction is based on a Merkle root of a Merkle tree constructed based on the respective script, wherein the respective target data is divided across one or more of the respective leaves of the respective Merkle tree.

18. (canceled)

19. The method of claim 8, wherein at least one of the respective scripts is a first locking script of a first output of the first blockchain transaction, and wherein the method comprises:
storing, in a database, the respective Merkle root mapped to the modified primary transaction and a respective index of the first output.

20. The method of claim 19, comprising:
obtaining a second blockchain transaction, wherein the second blockchain transaction comprises a first input that references the modified primary transaction identifier of the first blockchain transaction and the index of the first output, wherein the first input comprises a first unlocking script, and wherein the method comprises validating the second blockchain transaction by:
retrieving, from the database, the respective Merkle root mapped to the modified primary transaction identifier and the respective index of the first output;
determining a partial locking script of the first output based on the first unlocking script of the first input;
performing a Merkle proof of inclusion to confirm that the partial locking script is a respective leaf of the respective Merkle tree corresponding to the respective Merkle root; and
validating the first unlocking script against the partial locking script.

21. The method of claim 8, wherein at least one of the respective scripts is a first locking script of a first output of the first blockchain transaction, and wherein the method comprises:
storing, in a database, a partial locking script mapped to the modified primary transaction identifier and a respective index of the first output, wherein the partial locking script comprises at least some of the first locking script but not the target data.

22. The method of claim 21, comprising:
obtaining a second blockchain transaction, wherein the second blockchain transaction comprises a first input that references the modified primary transaction identifier of the first blockchain transaction and the index of the first output, wherein the first input comprises a first unlocking script, and wherein the method comprises validating the second blockchain transaction by:
retrieving, from the database, the respective partial locking script mapped to the modified primary transaction identifier and the respective index of the first output; and
validating the first unlocking script against the partial locking script.

23. (canceled)

24. The method of claim 1, wherein the redacted transaction comprises a plurality of fields, and wherein the method comprises:
generating a transaction Merkle tree, wherein respective a plurality of respective leaves of the transaction Merkle tree are formed from one or more fields of the redacted transaction; and
generating a secondary transaction identifier of the redacted transaction, wherein the secondary transaction identifier comprises a Merkle root of the transaction Merkle tree.

25-27. (canceled)

28. Computer equipment, comprising:
memory comprising one or more memory units; and
processing apparatus comprising one or more processing units, wherein the memory stores code arranged to run on the processing apparatus, the code being configured so as when run on the processing apparatus, the processing apparatus performs a method comprising:
obtaining a first blockchain transaction, the first blockchain transaction comprising one or more respective scripts comprising respective target data to be redacted;
for at least one of the one or more respective scripts, constructing a respective Merkle tree based on the respective script, wherein the respective target data is divided across one or more of the respective leaves of the respective Merkle tree, and
generating a redacted version of the first blockchain transaction by replacing the at least one respective script with a respective Merkle root of the respective Merkle tree.

29. A computer program embodied on non-transitory computer-readable storage media and configured so as, when run on one or more processors, the one or more processors perform a method comprising:
obtaining a first blockchain transaction, the first blockchain transaction comprising one or more respective scripts comprising respective target data to be redacted;
for at least one of the one or more respective scripts, constructing a respective Merkle tree based on the respective script, wherein the respective target data is divided across one or more of the respective leaves of the respective Merkle tree, and
generating a redacted version of the first blockchain transaction by replacing the at least one respective script with a respective Merkle root of the respective Merkle tree.
